(19) United States
(12) Patent Application Publication
(10) Pub. No.: US 2004/0097252 A1
(43) Pub. Date: May 20, 2004

(54) Method and device of non-selective identification for combat or action group

(76) Inventors: Serge Hethuin, Courbevoie (FR); Gregoire Eumurian, Argenteuil (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/663,994

(22) Filed: Sep. 17, 2003

(30) Foreign Application Priority Data
Sep. 24, 2002 (FR) 02 11790

(51) Int. Cl. H04B 7/00

(52) U.S. Cl. 455/518; 455/519

(57) ABSTRACT

A device for non-selective identification in a communications network comprises several users, the data being exchanged in the form of frames, wherein: at least each user has a data processor responsible for the management of the voice, data and video services; a user who is a master or group leader is equipped with a radio terminal, one or more directional antennas and a processor activated in “master” mode; several users Ui are each equipped with a radio terminal, one or more directional antennas and a processor placed in “slave” mode; a data frame comprises a “non-selective” identification device comprising at least one first part reserved for interrogation by one of the users and a second part enabling users concerned by the response to respond.

### BACKGROUND OF THE INVENTION

1. Field of the Invention

The present invention relates especially to a method and device enabling non-selective identification within a group of persons.

The group is formed, for example, by several persons taking rescue action, or again by combatants. The method uses especially the group's radio network. In the present application, the expression “non-selective identification” corresponds, for example, to the blind identification of action personnel in the same group, concealed from the interrogating party, either because of night or dusk, or again because of action in an urban or indoor environment (buildings, parking lots, basements etc.)

The system is designed to be used by night in outdoor environments or again at all times in indoor environments.

The invention can be applied chiefly to the identification of the members of an action team (infantrymen, special forces, maintenance teams in high-risk zones, firefighters, doctors etc.). However, it also concerns broader sections such as people buried after an earthquake etc.

An action group (comprising rescue workers, combatants etc.) is generally provided with a communications network to exchange sound, data and video services in real time with the following characteristics:

A typical range of more than 1200 m in open space.

Any frequency band between 200 MHz and 2 GHz.

An access protocol in TDMA or CSMA mode.

2. Description of the Prior Art

The prior art identification technique, illustrated in FIG. 1, is more generally based on:

an interrogation transmitted by laser beam, for obvious reasons of aiming at the action team member to be identified,

a response sent on a specific radio channel if the interrogated action team member is a friend; if not there is no response.

This technique cannot be used for interrogation through obstacles such as walls.

Another identification technique, closer to the radar domain, consists in sending out an electromagnetic wave and picking up the back-scattered energy. To discriminate between echoes coming from objects devoid of interest and persons or items that have to be detected, the back-scattered echo may be modulated by a particular pattern. If this technique is accompanied at reception by a two-antenna device and by the formation of sum and difference channels, then it can be used to detect the angular divergence between the interrogator-interrogated axis on the one hand and the axis of aim of the interrogator system on the other.

This technique too does not accept interrogation through obstacles because of the attenuation encountered.

The idea of the present invention lies especially in the implementation of a function of non-selective identification using a communications radio network of an action group without requiring any additional equipment.

To this end, an object of the invention is a device for radio interrogation through an (omnidirectional or directional) antenna on the interrogating individual and a radio responder device, working according to an anti-collision procedure, on the individuals located in the interrogation antenna lobe.

The originality of the system relies especially in the use of a specific part in the data frame relating to the radio network of the action group.

### SUMMARY OF THE INVENTION

The invention relates to a device for non-selective identification in a communications network comprising several users, the data being exchanged in the form of frames, wherein:

at least each user has a data processor responsible for the management of the voice, data and video services,

a user who is a master or group leader is equipped with a radio terminal, one or more directional antennas and a processor activated in “master” mode,

several users Ui are each equipped with a radio terminal, one or more directional antennas and a processor placed in “slave” mode,

a data frame comprises a “non-selective” identification device comprising at least one first part reserved for interrogation by one of the users and a second part enabling users concerned by the response to respond.

The user's processor in slave mode comprises, for example, a random or pseudo-random selection algorithm.

The radio access protocol in the communications network may be any protocol whatsoever.

The device comprising the characteristics given here above may be applied to a device in which the data exchanged have the format of a TDMA frame, the “non-selective” identification device being positioned between the packets of the uplink channel and the RCH access channel.

The invention also relates to a method of “non-selective” use in a communications network comprising several users, the exchanged data taking the form of a frame, wherein the method comprises at least the following steps:

designating a “group leader” user (this is normally done independently of the IDENTIFICATION function),

designating at least one user who is an interrogator or is authorized to interrogate in one or more frames in a given direction (directional antenna),

synchronizing the “interrogating” user with the start of the interrogation phase in the frame,

making use, if necessary according to the concerned mode, of a random or pseudo-random selection algorithm to compute the instant of response from the non-interrogating users in the frame.

The object of the invention especially has the advantage of using existing equipment.

The method can furthermore be applied whatever the type of access protocol used and whatever the waveform implemented.

Such an identification is therefore complementary to the selective identification which consists in seeking to identify an action team member (generally at a fair distance) who can be seen either with the naked eye or through sensors in the visible or again in the infrared domain. The expected response in the latter case is “friend” or “unknown”. The non-selective identification, on the contrary, is aimed at letting the interrogating party know whether or not he is surrounded in his vicinity by members of the same action group.

### BRIEF DESCRIPTION OF THE DRAWINGS

Other features and advantages of the device according to the invention shall appear more clearly from the following description, given by way of an illustration that in no way restricts the scope of the invention and made with reference to the appended drawings, of which:

FIG. 1 shows a prior art interrogation-response system,

FIG. 2 is a drawing of the interrogation-response device according to the invention,

FIG. 3 shows a classic mode of time division (TDMA) in a radio network,

FIG. 4 shows a modified mode of time division enabling the method of the invention to be implemented,

FIG. 5 is a time graph representing the signals sent and received by the interrogator according to the device according to the invention.

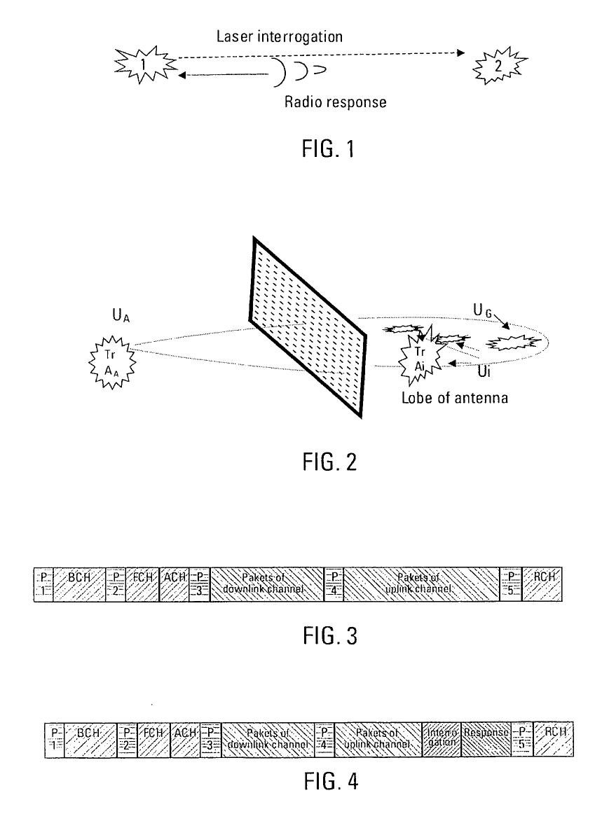

### MORE DETAILED DESCRIPTION

In order to make it easier to understand the object of the invention, the following description, which is given by way of an illustration that in no way restricts its scope, relates to a radio interrogation device as shown in FIG. 2.

The system shown schematically in FIG. 2 comprises, for example, a radio network, several individuals or users Ui each equipped with a radio terminal Tr and omnidirectional and/or directional antennas Ai (of the radio terminal), for example, as well as a data processor (not shown in the figure for the sake of simplification). This data processor has the function especially of managing the different services such as voice, data, video and other services to be transmitted by radio. The radio communications means, on which non-selective identification (NSI) between the members of the network may be based, may be of different types. The radio equipment may implement both a communications function and an identification function.

At the group level, an individual is designated as a “group leader” U_{G}. His data processor as well as his radio then work in “master” mode. The other users Ui of the group are each equipped with a data processor and a radio working in “slave” mode. The group leader's data processor takes an automatic or manually controlled decision on whether or not an individual asking to interrogate is to be accepted as an “interrogating individual” U_{A}.

According to a first alternative embodiment, and in order to limit the surface area and the volume of the zone of interrogation, each user's radio terminal is equipped, for example, with a directional antenna Ad. This antenna is placed for example on the torso at the level of the user's clothing, integrally joined to the direction of the torso, or on the arm or again on a pack with a handle, pointed in the direction to be explored.

Reduction of Power

In order to limit the number of responses and collisions in the interrogation zone, the “the non-selective identification” (NSI) system is, for example, provided with a device enabling a reduction in power. Each of the users of the group, for example, is equipped with this device. The reduction in power is made by the radio of the interrogating soldier, under the control of his data processor which asks or does not ask him for its activation. The power necessary for the interrogation is predefined. The passage to this value of this power is made, for example, when passing into the interrogation phase. In normal operation, only the (radio) terminal of the interrogating user has its power reduced when passing into interrogation phase. The terminals of the users who have to respond are, however, free to reduce or not reduce their power at the time of the response.

Algorithm for the Gradual Adjustment of Power

In order to locate friends or collaborators within the interrogation zone, the processor with which a user is equipped comprises, for example, an algorithm for the gradual adjustment of power. Thus, during a frame, the “interrogating” individual may interrogate with greatly reduced power, increase this power at the next frame and so on and so forth for several frames.

Frames Used

The method according to the invention is used, for example, whatever the type of access protocol used and whatever the type of waveform used.

For example, in CSMA/CA mode, as practiced according to the IEEE 802.11x (x=a, b, h, g, . . . ) standards, the access procedure consists in trying to transmit the packet as soon as it appears and in deferring this transmission by a variable and random delay if the medium is not free at this point in time. This procedure is quite practicable for the sending of data but has low compatibility with the real-time transmission of recurrent signals such as voice or radio signals. To overcome this problem and facilitate the transmission of these signals, this standard enables the implementation of a time-recurrent zone in the frame in which the non-selective identification procedure can also be applied.

In TDMA mode, it is proposed to reserve a part of the TDMA frame for the positioning of the non-selective identification device as described here below, comprising a part designed for the interrogation phase and a second part designed for the response phase.

Before giving a detailed description of the steps executed during the method according to the invention, a few points enabling a better understanding of the invention will be recalled.

TDM type Generic Frame in a Radio Network

FIG. 3 is a drawing of a frame in a TDMA (Time Division Multiple Access) network. In a TDMA network, the data are generally transmitted according to the cycle described in this FIG. 3.

Preambles:

P1 (before the broadcast from the master terminal),

P2 (before the allocation of resources, angular sector by angular sector),

P3 (before the downlinks from the masters to the slaves, each in turn),

P4 (before passing into uplink mode),

P5 (before starting the reservation phase)

Signaling:

BCH (Broadcasting CHannel): data broadcasting part used to deliver information common to all the users located within radio range of the master station.

FCH (Frame CHannel): part sent by the master station used to indicate the transmission zones in the current frame allocated to the different users to receive or transmit data.

ACH (Acknowledge CHannel): part used by the master station to inform certain users wishing to transmit information that their request has been properly taken into account and that the transmission will be allocated within a very short time.

RCH (Random access CHannel): part accessible to users wishing to send or receive information, enabling them to declare their request to the master station.

(Data Payload): Exchanges between the master station and the subscribers: data packets of defined length sent individually by the master station to the different users, each in turn.

Exchanges between users and the master station or with other users: data packets of defined length, sent by the users allowed to send, at the places allocated in the frame by the master station.

Frame Modified According to the Invention

The frame of FIG. 3 is modified, for example, according to the drawing of FIG. 4 by the insertion of a non-selective identification device. This device may be inserted at any place in the frame. The example given by way of an illustration represents a device inserted between the packets of the uplink channel and the RCH.

The non-selective identification device comprises for example:

a first part reserved for interrogation by one of the users, called an “interrogating user”,

a second part that enables non-interrogating but concerned users to respond.

In the case of a general operation, only one user at a time is authorized by the group leader to carry out interrogation in one frame. It is through the RCH access part, as in the case of communications, that the users may make a request to send in the frames that follow an interrogation. The user authorized to interrogate in a frame is informed in the FCH part, as in the case of the allocation of communications.

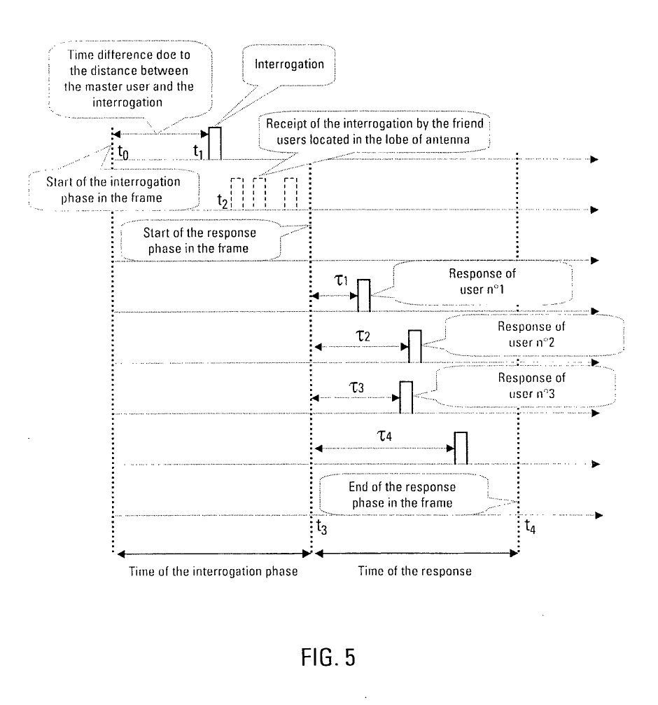

FIG. 5 gives a schematic view of an exemplary drawing of the exchanges that may take place in a phase of interrogation with responses.

The group leader authorizes the user U_{A} to interrogate in a given frame. The interrogating user U_{A} gets synchronized with the start of the interrogation phase in the frame, at the instant t₀. The difference between t₀ and t₁ corresponds to the time difference due to the distance between the master user U_{G} and the interrogator UA. From the instant t₂, the interrogation is received by the different users Ui located in the periphery of the interrogating user U_{A}.

The instant t₃ corresponds to the start of the response phase in the frame comprising the responses from the different users Ui. Between this instant and the instant t₄ of the end of the response phase, the concerned users Ui transmit their response to the interrogating user with delays respectively τ₁, τ₂, τ₃, τ₄ depending, firstly, on their position relative to the interrogating user and secondly on an additional time that may be selected at random within certain limits (see next paragraph).

The information on non-selective identification is then broadcast to all the users of the group.

For a 1500 m range of the communications system, the duration of the interrogation phase is greater than the sum of the transit time (4.5 μs) plus the duration of the interrogation itself. For example, with a modulation at 1 Mb/s and an interrogation formed by 3 bytes, the interrogation lasts 24 μs and with a guard time of 8 μs the interrogation zone is equal to 32 μs.

With respect to the responses, and to avert collision to the maximum extent, the users who receive the interrogation (and have to respond to it) use, for example, a pseudo-random selection algorithm to compute the instant at which the response is sent in the response phase. The instant of response may extend from 0 to a maximum period, for example 192 μs, in slots of a duration equal to the duration of the response (giving 24 μs on three bytes in using a modulation at 1 Mb/s). In all, by adding a guard time of 8 μs to take account of the transit time for the response from a user located at the limit of the interrogator's range, the duration of the response phase is equal to about 200 μs (8 time slots of 24 μs plus 8 μs). This algorithm is integrated, for example, into the radio terminal with which the user is equipped in responder mode.

The communications system manages the passage between operation in usual communications with the nominal antenna on the one hand and operation with a directional antenna for identification on the other hand. For this purpose, a switching operation is performed when the radio terminal of the interrogating user passes into the interrogation phase. In normal operation, only the terminal of the interrogating users switches over its antennas, while the other users remain with the nominal antennas (which are omnidirectional in principle).

Modes of Operation

Several modes of operation may be implemented; each of them corresponds to different phases of the action. The choice of the modes is done, in part, automatically while the rest is done manually, depending on the immediate conditions of the environment.

Thus, as indicated in the following table, successive users make use of modes without designation, modes with designation, modes with exclusion and finally modes with relaying.

| | | | Duration of | |
|---|---|---|---|---|
| | | | response | |
| Mode | Interrogation | Response | phase | Observation |
| Interrogation | 3 bytes | 3 bytes | 8 * 24 + 8 | 8 pseudo random |
| without | | (24 μs) | μs | selection slots |
| designation | | | | possible |
| Response: identity | | | | |
| friend | | | | |
| Interrogation with | 6 bytes | 9 + 1 bytes | 200 μs | No collision to be |
| designation | | (80 μs) | | feared |
| Response: GPS | | | | |
| position + validity | | | | |
| Interrogation with | 6 bytes | 200 μs | 200 μs | No collision to be |
| designation | | | | feared |
| Measurement of | | | | |
| distance and of | | | | |
| direction on the | | | | |
| response | | | | |
| Interrogation with | 6 bytes | 3 bytes | 8 * 24 + 8 | 8 pseudo-random |
| exclusion | | (24 μs) | μs | selection slots |
| Response: identity | | | | possible |
| friend | | | | |
| Interrogation with | 6 bytes | 3 bytes | 8 * 24 + 8 | 8 friends detectable |
| relay | | (24 μs) | μs | |
| Response: identity | | | | |
| friend | | | | |

Mode of Interrogation Without Designation

In this mode, the interrogation sent on three bytes (one signaling byte and two bytes for the interrogator's identity) implies a response on the part of all the action group members located in the zone of the antenna of the interrogator receiving the interrogation signal.

The response, from each terminal of a concerned interrogating user, comprises three bytes (one signaling byte and two bytes for the identity of the interrogated responder). The response phase, which lasts 200 μs for example, makes it possible to have 8 time slots of 24 μs or, in other words, 8 selection slots for the terminals.

The interrogation is made, for example, on several successive frames (only one interrogator throughout this time) so as to determine all the terminals concerned and prevent non-detection following a collision of only one frame sent.

Interrogation Mode with Designation and GPS Response

In this mode, the interrogation sent on six bytes (one signaling byte, two bytes for the interrogator's identity, three bytes to designate the interrogated terminal) implies a response solely on the part of the terminal of the user specified in the interrogation, provided that this user is within range of the interrogation antenna.

The response, from the terminal of the specified user, comprises ten bytes (nine bytes of GPS positions of the interrogated user and one validity byte). The frame is sent only once because there is no risk of collision between several terminals.

Interrogation Mode with Designation and Measurement of Distance and Direction

In this mode, the interrogation sent on six bytes (one signaling byte, two bytes for the interrogator's identity, three bytes to designate the interrogated terminal) implies a response solely on the part of the terminal specified in the interrogation, provided that this terminal is within range of the interrogation antenna.

The response from the specified terminal is a modulated signal, sent instantaneously upon reception of the interrogation to enable the interrogating terminal to carry out a measurement of distance and direction. The frame is sent only once because there is no risk of collision between several terminals.

Interrogation Mode with Exclusion

In this mode, the interrogation sent on six bytes (one signaling byte, two bytes for the interrogator's identity, three bytes to designate the excluded terminal) implies a response from all the users located in the zone of the antenna of the interrogator receiving the interrogation signal except the user designated in the interrogation.

The response from each interrogated terminal concerned comprises three bytes (one signaling byte and two bytes for the identity of the interrogated responder). The response phase, with a duration for example of 200 μs, makes it possible to have 8 time slots of 24 μs, in other words 8 selection slots for the terminals.

The interrogation is done on several successive frames (with only one interrogator throughout this time) so as to determine all the terminals concerned together and prevent non-detection following a collision during a single frame sent.

Interrogation Mode with Relay

In this mode, the interrogation sent on six bytes (one signaling byte, two bytes for the interrogator's identity, three bytes to designate the relay terminal) is instantaneously relayed by the designated relay terminal and, in turn, implies a response from all the members of the action group who are located in the zone of the antenna of the relay interrogator and receive the interrogation signal from this relay interrogator.

The response, from each interrogated terminal concerned, comprises three bytes (one signaling byte and two bytes for the identity of the interrogated responder). The response phase, with a duration for example of 200 μs, gives 8 time slots of 24 μs, in other words 8 random selection slots for the terminals. The responses obtained are transmitted by the relay to the interrogator with a delay of two frames during the response phase. There are then sequences of three successive frames: the first frame is to inform the node concerned of the request for relaying, the next frame is for the interrogation by the relay node and the obtaining of responses, and the third frame is used by the relay node to transmit the responses to the base interrogator.

Implementation of the Different Modes

The implementation of the different modes of operation is, for example, executed by automatic activation of the device according to a predefined chronology. Each chronology corresponds to a predetermined action scenario and the user chooses, for example, the scenario that is appropriate to him either before or during the mission (the number of scenarios is a very limited; it comprises a few scenarios at most).

The following example will enable the reader to get an idea of the sequencing of the operations when the individual presses the command to activate non-selective identification (NSI) only once.

‘Situation Report’ Scenario:

Activation of the NSI Command

Phase 1: Request to the master of the group to go into NSI Wait for positive response (with limit on the wait).

Phase 2: Acquisition of the existence of partners in the vicinity Activation of the option of adjustment of power sent

$$\begin{matrix}\{ \begin{matrix}1 s t sending of a frame in Mode WITHOUT designation with \\ Max Power \text{-} 36 dB \\ Sending of a frame with Exclusion if one partner or more is \\ detected\end{matrix} \\ … \end{matrix}$$

5th sending of a frame in Mode WITHOUT designation with Max Power-36 dB

Sending of a frame with Exclusion if one partner or more is detected

$$\begin{matrix}\{ \begin{matrix}1 st sending of a frame in Mode WITHOUT designation with \\ Max Power \text{-} 30 dB \\ Sending of a frame with Exclusion if one partner or more is \\ detected\end{matrix} \\ … \end{matrix}$$

5th sending of a frame in Mode WITHOUT designation with Max Power-30 dB

Sending of a frame with Exclusion if one partner or more is detected

. . .

$$…$$

$$\{ \begin{matrix}1 st sending of a frame in Mode WITHOUT designation with \\ Max Power \\ Sending of a frame with Exclusion if one partner or more is \\ detected\end{matrix}$$

5th sending of a frame in Mode WITHOUT designation with Max Power

Sending of a frame with Exclusion if one partner or more is detected

Phase 3: Display of the identity of the partners identified This display can be done on an LCD module that can be clipped on, as desired, on a wristwatch strap, a support fixed to the arm or again behind the directional antenna fixed to the combat or action jacket.

Phase 4: Acquisition of the GPS position of each partner identified or the distance from each of them.

The sending, for each of the partners identified, of a frame in the Mode WITH designation (either with a request for the GPS position externally or with a request for a measurement of distance internally or again with both) with the power corresponding to the power that had enabled detection

Phase 5: display of the identity and of the position of the identified partners

This display may be done on the same LCD module as earlier.

This set of transmitted frames lasts only about a hundred ms.

Use of the Different Antennas

According to one alternative embodiment, each individual or user is equipped, for example, for reasons of propagation, with several antennas. The antennas are, for example, distributed as follows: one (directional) antenna on the chest, another (directional) antenna on the back, one (directional) antenna on each shoulder.

It is then possible to implement the following configurations on the interrogator user:

Interrogation sent by all the antennas

Interrogation sent by the front antenna

Interrogation sent by the rear antenna

Interrogation sent by the right-shoulder antenna

Interrogation sent by the left-shoulder antenna

Interrogation sent in turn, frame after frame, by each antenna one after the other.

The front antenna, located on the chest, may be detachable and directed manually so that it is aimed in the preferred directions. The access protocol in the communications network may be any protocol. The mechanism of requesting authorization for interrogation for a user forms part of the basic reservation protocol.

What is claimed is:

1. A device for non-selective identification in a communications network comprising several users, the data being exchanged in the form of frames, wherein:
at least each user has a data processor responsible for the management of the voice, data and video services,
a user who is a master or group leader is equipped with a radio terminal, one or more directional antennas and a processor activated in “master” mode,
several users Ui are each equipped with a radio terminal, one or more directional antennas and a processor placed in “slave” mode,
a data frame comprises a “non-selective” identification device comprising at least one first part reserved for interrogation by one of the users and a second part enabling users concerned by the response to respond.

2. A device according to claim 1, wherein the user's processor in slave mode comprises, for example, a random or pseudo-random selection algorithm.

3. A device according to one of the claims 1 to 2, wherein the radio access protocol in the communications network may be any protocol whatsoever.

4. A device according to claim 1, wherein a user is equipped with one or more directional antennas, positioned either on the torso on the user's clothing and integral with the direction of the torso, or on the arm or on a pack that has a handle and is pointed in the direction that is to be exposed.

5. A device according to claim 1, wherein the users are equipped with a power limiter.

6. A device according to claim 5, comprising means adapted to adjusting the power sent out by the interrogator.

7. A use of a device according to claim 1 in a communications network where at least one data frame in the TDMA format, the <<non-selective>> identification device being positioned between the packets of the uplink channel and the RCH access channel.

8. A method of “non-selective” use in a communications network comprising several users, the exchanged data taking the form of a frame, wherein the method comprises at least the following steps:
designating a “group leader” user,
designating at least one user who is an interrogator or is authorized to interrogate in one or more frames in a given direction (directional antenna),
synchronizing the “interrogating” user with the start of the interrogation phase in the frame,
making use, if necessary according to the concerned mode, of a random or pseudo-random selection algorithm to compute the instant of response from the non-interrogating users in the frame.

9. A method according to claim 8 wherein, during the passage into the interrogation phase, the terminal of the interrogating user may or may not reduce its power.

10. A method according to claim 9, wherein the power reduction is gradual.

11. A method according to claim 8, wherein there is a mode of interrogation without designation in which all the users receiving the interrogation signal respond to each frame of the interrogation cycle of the same interrogating user.

12. A method according to claim 8 wherein there is a mode of interrogation without designation in which all the users receiving the interrogation signal respond once by giving their identity and then stop responding in the rest of the interrogation cycle of the same interrogating user.

13. A method according to claim 8, wherein there is a mode of interrogation with designation in which only the user terminal addressed responds if it receives the interrogation signal and communicates its GPS position in the response.

14. A method according to claim 8, wherein there is a mode of interrogation with designation in which only the addressed user terminal responds if it receives the interrogation signal and sends a predefined signal to enable the interrogator to measure the distance between them and determine the direction in which the terminal addressed is located.

15. A method according to claim 8, wherein there is an interrogation mode with exclusion in which all the users receiving the interrogation signal, except for the excluded terminal, must respond in giving their identity.

16. A method according to claim 8, wherein there is an interrogation mode with relay in which the interrogation is transmitted by a relay terminal, designated in the interrogation signal of the interrogator terminal and in which all the users receiving the interrogation signal from the relay terminal must respond.
